(19) United States
(12) Patent Application Publication
(10) Pub. No.: US 2021/0356156 A1
(43) Pub. Date: Nov. 18, 2021

(54) A METHOD FOR DETECTING OPERATING POWER OF AIR CONDITIONER COMPRESSOR, AND AIR CONDITIONER

(71) Applicant: QINGDAO HAIER AIR CONDITIONER GENERAL CORP., LTD., QINGDAO, Shandong Province (CN)

(72) Inventors: LIN MA, QINGDAO, SHANDONG PROVINCE (CN); YUNTAO LIU, QINGDAO, SHANDONG PROVINCE (CN); GUOJING XU, QINGDAO, SHANDONG PROVINCE (CN); JUKE LIU, QINGDAO, SHANDONG PROVINCE (CN); YONGFU CHENG, QINGDAO, SHANDONG PROVINCE (CN)

(21) Appl. No.: 16/625,595

(22) PCT Filed: Jun. 25, 2018
(86) PCT No.: PCT/CN2018/092557

§ 371 Date: Dec. 20, 2019

(30) Foreign Application Priority Data
Jun. 26, 2017 (CN) 201710493886.1

(51) Int. Cl. F24F 11/46; F24F 11/52; F24F 11/64; F24F 11/77

(52) U.S. Cl. CPC F24F 11/46; F24F 11/52; F24F 2140/60; F24F 11/77; F24F 11/64

(57) ABSTRACT

Provided is an air conditioner compressor operating power detecting method comprises: detecting a compressor driving power supply frequency as the air conditioner running; calculating a drive power supply period T based on the detected drive power supply frequency f wherein the drive power supply period T=1/f; the driving power supply period T is equally divided into n time segments; and in each time segment, respectively sampling a compressor drive voltage, respectively sampling a compressor drive current in each time segment; calculating a voltage reference value U′; calculating a current reference value I′; obtaining a plurality of voltage reference values U′; obtaining a plurality of current reference values I′; calculating a mean voltage reference value Uₘₑₐₙ, calculating a mean current reference value Iₘₑₐₙ, calculating a compressor operating power P_{compressor}. Another aspect is provided an air conditioner. The invention has advantages of being accurate in calculation.

### TECHNICAL FIELD

The present invention relates to the field of air conditioning equipment, and in particular, to a compressor operating power detecting method, and an air conditioner using the same.

### BACKGROUND TECHNOLOGY

High energy cost of air conditioner is an important reason limiting it being widespread, especially among households, which makes the vulnerable ones reluctant to use it in routine life. In fact, people can barely learn actual power consumption of various components within air conditioner, particularly which varies in different operating modes. The basic understanding of most people of how much power an air conditioner really consumes comes from publicity of popular science news or traditional conception of household appliances. In fact, this knowledge is not only unable to help users to save energy, but guiding them to use air conditioner in an unwise way. In order to avoid high electricity bill, they are willing to partially sacrifice using experiences, some of them tend to switch air conditioner on and off frequently supposing the break could lower electricity consumption. However, it turns out those actions only could give the opposite effect. It has been realized that the compressor is the most energy-consuming component within an air conditioner. If the user could clearly understand the power consumption of the compressor, it could guide people to manage their usage of the air conditioner in a better way with no experience sacrifice and a much lower electricity cost.

### SUMMARY OF THE INVENTION

The present invention aims to provide an air conditioner compressor operating power detecting method with which the operating power of compressor could be calculated much more accurately.

A method for detecting operating power of an air conditioner compressor includes the following steps:

Detecting a compressor driving power supply frequency f as the air conditioner running;

Calculating a drive power supply period T based on the detected drive power supply frequency f wherein the drive power supply period T=1/f;

The driving power supply period T is equally divided into n time segments; and in each time segment, respectively sampling a compressor drive voltage, which are denoted as U₁, U₂, U₃, . . . , Uₙ;

Respectively sampling a compressor drive current in each time segment, which are denoted as I₁, I₂, I₃, . . . , Iₙ;

$${U}^{′} = \sqrt{\frac{{U}_{1}^{2} + {U}_{2}^{2} + {U}_{3}^{2} + ⋯ + {U}_{n}^{2}}{n}} ;$$

Calculating a voltage reference value U′, wherein

$${I}^{′} = \sqrt{\frac{{I}_{1}^{2} + {I}_{2}^{2} + {I}_{3}^{2} + ⋯ + {I}_{n}^{2}}{n}} ;$$

Calculating a current reference value I′, wherein

Obtaining a plurality of voltage reference values U′ and which are denoted as U₁′, U₂′, U₃′, . . . , Uₓ′;

Obtaining a plurality of current reference values I′ and which are denoted as I₁′, I₂′, I₃′, . . . , Iₓ′;

$${U}_{mean} = \frac{{U}_{1}^{′} + {U}_{2}^{′} + … + {U}_{x}^{′}}{x} ;$$

Calculating a mean voltage reference value Uₘₑₐₙ, wherein

$${I}_{mean} = \frac{{I}_{1}^{′} + {I}_{2}^{′} + … + {I}_{x}^{′}}{x} ;$$

Calculating a mean current reference value Iₘₑₐₙ, wherein

Calculating a compressor operating power P_{compressor}, P_{compressor}=\sqrt{3}UₘₑₐₙIₘₑₐₙ;

Considering the data processing capability of a controller within air conditioner, preferably n∈[30, 50], wherein n is a positive integer.

Preferably, x∈[10, 25], x is a positive integer.

Another aspect of this invention discloses an air conditioner, wherein the compressor operating power is detected by a method comprises:

Detecting a compressor driving power supply frequency f as the air conditioner running;

Calculating a drive power supply period T based on the detected drive power supply frequency f, wherein the drive power supply period T=1/f;

The driving power supply period T is equally divided into n time segments; and in each time segment, respectively sampling a compressor drive voltage, which are denoted as U₁, U₂, U₃, . . . , Uₙ;

Respectively sampling a compressor drive current in each time segment, which are denoted as I₁, I₂, I₃, . . . , Iₙ;

$${U}^{′} = \sqrt{\frac{{U}_{1}^{2} + {U}_{2}^{2} + {U}_{3}^{2} + ⋯ + {U}_{n}^{2}}{n}} ;$$

Calculating a voltage reference value U′, wherein

$${I}^{′} = \sqrt{\frac{{I}_{1}^{2} + {I}_{2}^{2} + {I}_{3}^{2} + ⋯ + {I}_{n}^{2}}{n}} ;$$

Calculating a current reference value I′, wherein

Obtaining a plurality of voltage reference values U′ and denoted as U₁′, U₂′, U₃′, . . . , Uₓ′;

Obtaining a plurality of current reference values I′ and denoted as I₁′, I₂′, I₃′, . . . , Iₓ′;

Calculating a mean voltage reference value Uₘₑₐₙ, wherein

$${U}_{mean} = \frac{{U}_{1}^{′} + {U}_{2}^{′} + … + {U}_{x}^{′}}{x} ;$$

Calculating a mean current reference value Iₘₑₐₙ, wherein

$${I}_{mean} = \frac{{I}_{1}^{′} + {I}_{2}^{′} + … + {I}_{x}^{′}}{x} ;$$

Calculating a compressor operating power P_{compressor}, P_{compressor}=\sqrt{3}UₘₑₐₙIₘₑₐₙ;

In the air conditioner provided by the present invention, the operating power of an indoor unit is detected by procedures:

An indoor unit main board power P_{g′} is equal to the rated power of the chip;

An indoor display module power Pₓ is equal to a sum of a power of a control board of the indoor display module and a total power of signal lights radiating;

An indoor fan power P_{f1}: if the drive duty ratio of the indoor fan d<d₁, the indoor fan power P_{f1}=P₁; if the drive duty ratio of the indoor fan satisfies dₘ₋₁<d<dₘ, the indoor fan power

$${P}_{f 1} = ( {P}_{m} - {P}_{m - 1} ) \frac{d - {d}_{m - 1}}{{d}_{m} - {d}_{m - 1}} + {P}_{m - 1} ;$$

if the drive duty ratio of the indoor fan d>d_{q}, the indoor fan power P_{f1}=P_{q}, where 1≤m≤q, m, q are integers, m and q∈[1,5], where d₁, dₘ₋₁, dₘ, d_{q} are constants increasing, and P₁, Pₘ₋₁, Pₘ are preset values increasing;

An electric heating power Pₜ is equal to a rated electric heating power Pₜ₀;

A total indoor unit power P_{indoor}, which satisfies P_{indoor}=P_{g′}+Pₓ+P_{f1}+Pₜ.

In order to correct the electric heating power, the operating power of an indoor unit is detected by procedures:

An indoor unit main board power P_{g′} is equal to the rated power of the chip;

An indoor display module power Pₓ is equal to a sum of a power of a control board of the indoor display module and a total power of signal lights radiating;

An indoor fan power P_{f1}: if the drive duty ratio of the indoor fan d<d₁, the indoor fan power P_{f1}=P₁; if the drive duty ratio of the indoor fan satisfies dₘ₋₁<d<dₘ, the indoor fan power

$${P}_{f 1} = ( {P}_{m} - {P}_{m - 1} ) \frac{d - {d}_{m - 1}}{{d}_{m} - {d}_{m - 1}} + {P}_{m - 1} ;$$

if the drive duty ratio of the indoor fan d>d_{q}, the indoor fan power P_{f1}=P_{q}, where 1≤m≤q, m, q are integers, where d₁, dₘ₋₁, dₘ, d_{q} are constants increasing, and P₁, Pₘ₋₁, Pₘ are preset values increasing;

An electric heating power Pₜ is equal to a sum of a preset electric heating power Pₜ₀ and a compensated electric heating power P_{t′}, corresponding to each of the data segments of the drive duty ration of the indoor fan a corresponding correction weight w is assigned; within each of the range, the compensated electric heating power P_{t′} increases as the drive duty ratio of the indoor fan increases and the increment of the compensated electric heating power P_{t′} is equal to an accumulated value of each of multiplication result of the segment and the correction weight w;

As the indoor fan is running, the electric heating power Pₜ satisfies Pₜ=(Pₜ₀+P_{t′})×k₁, wherein k₁ is an air deflector correction coefficient and the air deflector correction coefficient increases as the angle of the air deflector from the original position increases, and k₁∈(0.9, 1.1).

A total indoor unit power P_{indoor}, which satisfies P_{indoor}=P_{g′}+Pₓ+P_{f1}+Pₜ.

In the air conditioner provided by the present invention, the operating power of an outdoor unit is detected by procedures:

An outdoor unit main board power P_{g} is equal to the rated power of the chip;

An outdoor fan power P_{f2} is:

If the outdoor fan is a DC fan, the outdoor fan power P_{f2} could be detected by measuring a drive duty ration of the outdoor fan. If the drive duty ratio of the outdoor fan d<d₁, the outdoor fan power P_{f2}=P₁; if the drive duty ratio of the outdoor fan satisfies dₘ₋₁<d<dₘ, the outdoor fan power

$${P}_{f 1} = ( {P}_{m} - {P}_{m - 1} ) \frac{d - {d}_{m - 1}}{{d}_{m} - {d}_{m - 1}} + {P}_{m - 1} ;$$

if the drive duty ratio of the outdoor fan d>d_{q}, the outdoor fan power P_{f2}=Pq, where 1≤m≤q, m,q are integers, where d₁, dₘ₋₁, dₘ, d_{q} are constants increasing, and P₁, Pₘ₋₁, Pₘ are preset values increasing;

If the outdoor fan is an AC fan, firstly selecting a rated power preset value P_{f2′} according to the speed of the outdoor fan; the outdoor fan power P_{f2} is equal to the result by multiplying the rated power preset value P_{f2′} and a voltage correction coefficient k₂, and the outdoor fan power P_{f2} increases as the mains voltage increases, k₂∈(0.9, 1.1).

An electronic expansion valve power P_{d} is equal to the rated power of the electronic expansion valve;

A four-way valve power is equal to the rated power of the four-way valve;

A total indoor unit power P_{outdoor}, which satisfies P_{outdoor}=P_{g}+P_{f2}+P_{d}+Pₛ+P_{compressor}.

Further, if the outdoor fan is an AC fan, t setting two fan speed categories and each of the fan speed category is assigned a rated power, which are denoted by P₀₁ and P₀₂; determining which fan speed category the current fan speed belongs to and selecting corresponding rated power as the rated power preset value P_{f2′}.

The air conditioner disclosed by the present invention has an advantage of being accurate in calculating the electricity consumption.

### DRAWINGS

The present invention may be better understood, and its numerous objects, features and advantages made apparent to those skilled in the art by the accompanying drawing. The use of the same reference number throughout the several figures designates a like or similar element.

### BRIEF DESCRIPTION OF THE DRAWING

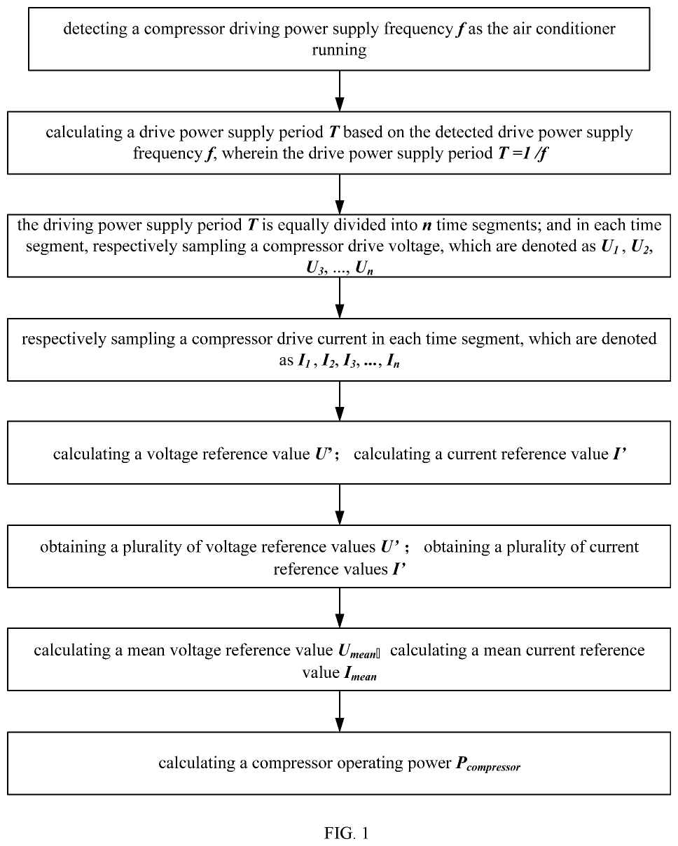

FIG. 1 is a flow chart of a method for detecting operating power of compressor of air conditioner according to one embodiment of the present invention.

### DETAILED DESCRIPTION OF THE EMBODIMENTS

The following describes embodiments of the present invention with reference to the attached drawing.

FIG. 1 is a flow chart of a method for detecting operating power of compressor of air conditioner, which comprises: firstly detecting a compressor driving power supply frequency f as the air conditioner running, wherein the compressor driving power supply frequency f is a detected power supply frequency of a driving unit of the compressor which could be detected by an oscilloscope at the power supply end of the driving unit. The measurement of the power supply frequency could adopt any one of method disclosed by the prior art and those details are not described further herein. Normally, the drive power supply frequency f could be started to measure until the compressor is on and stably running for 3 seconds.

Then calculating a drive power supply period T based on the detected drive power supply frequency f, wherein the drive power supply period T=1/f.

The driving power supply period T is equally divided into n time segments; and in each time segment, respectively sampling a compressor drive voltage, which are denoted as U₁, U₂, U₃, . . . , Uₙ;

Respectively sampling a compressor drive current in each time segment, which are denoted as I₁, I₂, I₃, . . . , Iₙ;

$${U}^{′} = \sqrt{\frac{{U}_{1}^{2} + {U}_{2}^{2} + {U}_{3}^{2} + ⋯ + {U}_{n}^{2}}{n}} ;$$

Calculating a voltage reference value U′, wherein

$${I}^{′} = \sqrt{\frac{{I}_{1}^{2} + {I}_{2}^{2} + {I}_{3}^{2} + ⋯ + {I}_{n}^{2}}{n}} ;$$

Calculating a current reference value I′, wherein

Obtaining a plurality of voltage reference values U′ and denoted as U₁′, U₂′, U₃′, . . . , Uₓ′;

Obtaining a plurality of current reference values I′ and denoted as I₁′, I₂′, I₃′, . . . , Iₓ′;

$${U}_{mean} = \frac{{U}_{1}^{′} + {U}_{2}^{′} + … + {U}_{x}^{′}}{x} ;$$

Calculating a mean voltage reference value Uₘₑₐₙ, wherein

$${I}_{mean} = \frac{{I}_{1}^{′} + {I}_{2}^{′} + … + {I}_{x}^{′}}{x} ;$$

Calculating a mean current reference value Iₘₑₐₙ, wherein

Calculating a compressor operating power P_{compressor}, P_{compressor}=\vec{3}UₘₑₐₙIₘₑₐₙ;

In principle, the larger the values of n and x are assigned, the closer the calculated mean voltage reference value and the mean current reference value are to the RMS (Root Mean Square) voltage and the RMS (Root Mean Square) current, and the calculated compressor operating power P_{compressor} is more accurate. However, considering the data processing capability of a controller within air conditioner, preferably n∈[30, 50] and x∈[10, 25], wherein n is a positive integer and x is a positive integer.

In this method, the calculation of the voltage reference value and the current reference value could not only effectively reduce the influence of the irregular fluctuation of the plurality of discrete random sampling variables on the accuracy of the calculation of the RMS voltage and the RMS current, but also eliminate the abnormal values. The double sampling procedures could keep raw information contained in the original signals in a better way so as to improve the accuracy of the calculation of the operating power of the compressor in another aspect and also provide an exact data base for the subsequent calculation of the power consumption of the air conditioner. A statistical period could be set by the user or by the manufacturer and the actual power consumption could be calculated on the basis of the compressor operating power and the statistical period.

The compressor operating power detecting method disclosed in the above embodiment could be applied to an air conditioner as a part of a measurement method of the power of the air conditioner, or as a part of a measurement method of the electricity consumption of the outdoor unit of the air conditioner. Another aspect of the invention is to disclose an air conditioner using the compressor operating power detecting method as disclosed above. The detailed procedures of the compressor operating power detecting method could be referred to the description above and the flow chart shown in FIG. 1. The air conditioner using the method could achieve the same technical effect.

The compressor operating power detecting method disclosed in the above embodiment could be applied as a part of air conditioner electricity consumption detection. The following further provides a detailed description of the air conditioner electricity consumption detection as mentioned. As measuring how much energy does the air conditioner actually use in running, an independent data processing device, preferably an independent MCU chip (microcontroller unit) is assigned to handle the workload of data processing, so as to facilitate the calculation and improve accuracy via the enhanced operational capability throughout the whole process of electricity consumption detection; then of course the second best solution is to use the built-in controller of the air conditioner to perform calculation. As the electricity consumption detection running, the data processing device receives a first input command including a pair of on-off signals, namely an on signal and an off signal. The first input command may be generated from a remote control device of the air conditioner which could be a typical infrared remote controller or an intelligent terminal remote controller with an open software interface. The first input command also may be transmitted from the main-board within the indoor unit of air conditioner; such as that the main-board receives a remote signal and then generates and transmits the first input command to the data processing device. The data processing device responds to the first input command so as to learn the current on or off state of the air conditioner. The data processing device could also receive a standby command including a standby signal; as receiving the standby command, the data processing device responds to the standby command so as to learn the standby state of the air conditioner, and then to monitor the electricity consumption as the air conditioner in the standby state, which normally consumed by display devices and the leakage of built-in power supply module and chips of air conditioner.

Before running the electricity consumption detection, the data processing device also receives a second input command including one or more timing signals, wherein each of the timing signals indicates a fixed timing period, during which the energy consumed by the air conditioner will be calculated. The timing period could be set by the user, or written by the manufacturer before delivery. The data processing device responds to the second input command to acquire the set timing period. Preferably, the duration of the timing period lasts for several hours, because those timescales are sufficient to keep the operating state of air conditioner relatively stable. It should be noted that within a process from the air conditioner being switched on to the air conditioner being switch off, the data processing device may receive two or more second input commands so as to adjust the timing periods accordingly.

The data processing device correlates the first input command and the second input command, and then calculates an indoor unit power and an outdoor unit power during the timing period, which is also determined according to the timing signal. Particularly, the data processing device determines how the indoor unit power and the outdoor unit power vary within the duration from the air conditioner being switching on to being switch off according to the set timing period; and also calculates the electricity consumption at set time nodes within the period. The indoor unit power includes one or more single module power value from an indoor unit main-board power, an indoor display module power, an indoor fan power, and an electric heating power. The outdoor unit power includes one or more single module power value from an outdoor unit main-board power, a compressor operating power, an outdoor fan power, an electronic expansion valve power and a four-way valve power. The data processing device calculates and stores each of the single module power value independently, and each of them could be called independently. Furthermore, the data processing device is also configured to determine whether each of the single module power within a correct range; if one of the power value exceeds the boundaries, the data processing device generates a warning signal.

The data processing device also receives a third input command including a module selection signal. The data processing device responds to the third input command to acquire the information that which single modules are selected. The default setting of the module selection signal includes all of the modules of the indoor unit and the outdoor unit. That is to say, basically the data processing device is configured to calculate the sum of every single module power values as the air conditioner working in the status input by the first input command during the timing period input by the second input command. Preferably, the user is allowed to adjust the module selection signal, such as the user could actively input a third input command including a module selection signal configured to change the original selected modules to the data processing device through a remote terminal directly or through the indoor unit main-board which is in communication with the data processing device. As an example, the user could input a module selection signal to choose to learn how much electricity is used by the selected module or the power of the selected module, or to learn how much electricity is used by the indoor unit or the power of the indoor unit, or to learn how much electricity is used by the outdoor unit or the power of the outdoor unit. To those actively settled third input commands, the data processing device responds to the third input command and calculates the indoor unit electricity consumption or the indoor unit power, as well as the outdoor unit electricity consumption or the outdoor unit power according to the correlated first input command, second input command and third input command. The indoor unit electricity consumption or the indoor unit power, and/or the outdoor unit electricity consumption or the outdoor unit power could be further called, displayed and/or outputted to a certain user terminal, server, cloud server or a display device of the air conditioner. Preferably, the third input command is one from a group of coded signals input by a remote controller, which respectively corresponds to one different selected result: selecting one module, selecting all of the single modules of the indoor unit; selecting all of the single modules of the outdoor unit; selecting all of the single modules of the air conditioner. The coded signal is generated through actions on the keys of the remote controller. Taking the display as an example, the data processing device receives one of the coded signal and then output the calculation result to a designated display device of the air conditioner to enable the display device to display the electricity consumption of the selected single module, the electricity consumption of the indoor unit, the electricity consumption of the outdoor unit, or the electricity consumption of the air conditioner during the set timing period continuously or at intervals, such that the user could comprehend how much electricity is used by each of the functional component during the set timing period. The independently provided data processing device could ensure that the calculation of each of the single module could not be interfered by other modules or by the running modes of air conditioner, with advantages of being accurate and responsive. Furthermore, during the process of calculation, based on the on and off time determined by the on and off signals input by the first input command and the clock built-in the MCU, the data processing unit further could obtain the current season as the air conditioner running and outdoor environmental parameters; those information could be upload to the cloud server where the outdoor environmental parameters, the running time of air conditioner and the electricity consumption of each of the single module relates with each other to generate a relationship which could be used as a database to optimize the control of air conditioner, or to generate graphs and charts for guiding the user to use the air conditioner in a proper way. Such analysis does not involve the parameters varying frequently such as temperatures detected at different places of heat exchangers, indoor temperature or environment temperature, and therefore the user could easily comprehend the result.

Taking the display as an example, during the calculation process according to the first input command, the second input command and the third input command to obtain electricity consumption of a single module, the indoor unit, the outdoor unit or the air conditioner, the value for display is a variable sum value which is continuously being added onto. There is inevitably going to create some data redundancy in accumulating due to transmission delay and the limits of data processing capability of the data processing device. In order to reduce data redundancy, the data processing device firstly responds to the third input command, and then determines whether the power variation trend of the selected module input by the module selection signal within the set timing period input by the timing signal satisfies a preset condition; if the power variation trend satisfies the preset condition, the data processing device correlates the information input by the first input command, the second input command and the third input command and output a calculated electricity consumption of the chosen indoor unit or the outdoor unit based on current operating power simultaneously for displaying or further transmitting, and in the meanwhile record corresponding time nodes; if the power variation trend does not satisfy the preset condition, then the data processing device takes the end point of the timing period as a time node and at that point to correlate the information input by the first input command, the second input command and the third input command and output a calculated electricity consumption of the chosen indoor unit or the outdoor unit based on the power detected at the end point of the timing period for displaying or further transmitting, so as to avoid frequent conversion calculations, and further leading to a reduced data processing amount and low data redundancy, such that the error between the sum of every single module calculation value and the accumulation could be reduced to improve the overall accuracy.

The preset condition preferably configured is to determine whether an increment of the selected module power is greater than a preset increment value over the timing period. The increment is specifically defined as the absolute value of the selected module power between two consecutive time nodes, for example, an increment of the selected module power over one second. If the increment of the selected module power is greater than the preset increment value, the data processing device correlates the information input by the first input command, the second input command and the third input command and output a calculated electricity consumption of the chosen indoor unit or the outdoor unit based on the power detected for displaying or further transmitting, and in the meanwhile record corresponding time nodes; if the increment of the selected module power is not greater than the preset increment value, the data processing device takes the end point of the timing period as a time node and at that point to correlate the information input by the first input command, the second input command and the third input command and output a calculated electricity consumption of the chosen indoor unit or the outdoor unit based on the power detected at the end point of the timing period for displaying or further transmitting; preferably, the preset increment value∈(5 W, 10 W).

In another aspect, the data processing device outputs the calculated electricity consumption to a server for storage, such that the user could query the specific electricity consumption at any time node. The data processing device receives a fourth input command including one or more inquiry signal, and then output the inquiry signal to the server; the server responds to the inquiry signal and calls upon the stored electricity consumption over a certain time period input by the inquiry signal. For example, the air conditioner keeps running during the time period [T₁, T₂], an inquiry signal could be input to acquire the electricity consumption within the portion of time, the server responds to the inquiry signal to call upon the electricity consumption at a plurality of time nodes, and then outputs the result for further transmitting or displaying.

The environmental parameters having impacts on the working of air conditioner are complex, particularly which involve a coupled relationship among various built-in functional components in different operational states, so it neither has a direct way to clearly determine the relationship, nor a simple mathematical model to illustrate how the environmental parameters impact on the running of the components. In order to compensate the error on the calculation of electricity consumption caused by the coupled relationship, in the present invention, the power of each of the module is detected independently, so is the calculation of the electricity consumption.

To be specific, in order to achieve the above-mentioned object, a detailed description on how to calculate a total power of the indoor unit is interpreted as follows.

The total power of the indoor unit includes an indoor unit main board power P_{g′}. The indoor unit main board power P_{g′} is equal to the rated power of the chip, or it is mainly determined by a sum of the working power of the built-in chip and leakage of other standby components in principle. Generally the indoor unit main board power P_{g′} is in a range from 0-5 W. If the indoor unit main board is selected according to the first input command and the second input command, the data processing device could determine whether the power variation trend of the indoor unit main board satisfies the preset condition by comparing the detected power variation with the thresholds of the range; if it is within the range, the data processing device stores the power of the module and then outputs.

The total power of the indoor unit further includes an indoor display module power Pₓ. The indoor display module power Pₓ is equal to a sum of a power of a control board of the indoor display module, which is denoted by P_{g″} and a total power of signal lights radiating, which is denoted by P″, wherein the power of the control board is a total power of ongoing working electronic components of the control board, and the total power of signal lights radiating P″=P_{L}*X, wherein P_{L} is a power of a single signal light, and x is the number of the signal lights radiating.

The total power of the indoor unit includes an indoor fan power P_{f1}. The indoor fan power P_{f1} could be detected by measuring a drive duty ratio of the indoor fan, which is denoted by d. If the drive duty ratio of the indoor fan d<d₁, the indoor fan power P_{f1}=P₁; if the drive duty ratio of the indoor fan satisfies dₘ₋₁<d<dₘ, the indoor fan power

$${P}_{f 1} = ( {P}_{m} - {P}_{m - 1} ) \frac{d - {d}_{m - 1}}{{d}_{m} - {d}_{m - 1}} + {P}_{m - 1} ;$$

if the drive duty ratio of the indoor fan d>d_{q}, the indoor fan power P_{f1}=P_{q}, where 1≤m≤q, m, q are integers, m and q∈[1,5], where d₁, dₘ₋₁, dₘ, d_{q} are constants increasing, and P₁, Pₘ₋₁, Pₘ are preset values increasing; preferably, q=5, d₁=10%, d₂=30%, d₃=60%, d₄=85%, d₅=95%, P₁=7 W, P₂=22 W, P₃=46 W, P₄=90 W, P₅=110 W. For example, if the drive duty ratio of the indoor fan is 70%, the indoor fan power

$${P}_{f 1} = ( {P}_{m} - {P}_{m - 1} ) \frac{d - {d}_{m - 1}}{{d}_{m} - {d}_{m - 1}} + {P}_{m - 1} = 63.6 W .$$

As being applied for calculating the power of other types of air conditioner, merely adjustments on the constants according to the capabilities of various motors should be made such that the electricity consumption of the indoor fan could be obtained independently and there is no need to deduce new empirical formulas according to results from redetections.

The total power of the indoor unit further includes an electric heating power Pₜ, wherein the electric heating power Pₜ is equal to a rated electric heating power Pₜ₀.

The total indoor unit power, which is denoted by P, satisfies P=P_{g′}+Pₓ+P_{f1}+Pₜ.

The electricity consumption of the indoor unit of air conditioner in the timing period could be calculated on the basis of the total indoor unit power P. When the user inputs a third input command to select one of the modules, the electricity consumption of the selected module in the timing period also could be calculated on the basis of the power of a single module.

Under most of normal working conditions, the electric heating power Pₜ would be impacted by the working of the indoor fan. In order to improve calculation accuracy of the electric heating power Pₜ and compensate the error caused by the operating state of the indoor fan, as a preferably method, the electric heating power Pₜ is equal to a sum of a preset electric heating power Pₜ₀ and a compensated electric heating power P_{t′}, wherein the compensated electric heating power P_{t′} increases as the drive duty ratio of the indoor fan increases. The preset electric heating power Pₜ₀ is a constant value which could be selected according to the capability of electric heater. The compensated electric heating power P_{t′} relates to the speed of the indoor fan. The drive duty ratio could be divided into several data segments. Preferably, corresponding to each of the data segments of the drive duty ration of the indoor fan a corresponding correction weight w is assigned; within each of the range, the compensated electric heating power P_{t′} increases as the drive duty ratio of the indoor fan increases and the increment of the compensated electric heating power P_{t′} is equal to an accumulated value of each of multiplication result of the segment and the correction weight w. For example, to a certain type of electric heater, the preset electric heating power Pₜ₀ is 630 W, the drive duty ratio could be divided into several data segments and a corresponding correction weigh w is assigned to each of the data segment, which is shown in a table as follows:

| d | 40%-50% | 50%-60% | 60%-80% | 80%-95% |
|---|---|---|---|---|
| w | 700 | 700 | 300 | 200 |

If it is detected that the drive duty ratio of the indoor fan is 70%, the compensated electric heating power P_{t′}=(50%−40%)×700+(60%−50%)×700+(70%−60%)×300=170 W, the electric heating power Pₜ is equal to a sum of a preset electric heating power Pₜ₀ and a compensated electric heating power P_{t′}, that is 630 W+170 W=800 W.

As the indoor fan is running, the electric heating power would also be impacted by position of the air deflector. In order to compensate the error caused by the position of the air deflector, if the indoor fan is running, the electric heating power Pₜ satisfies Pₜ=(Pₜ₀+P_{t′})×k₁, wherein k₁ is the air deflector correction coefficient and the air deflector correction coefficient increases as the angle of the air deflector from the original position increases and k₁∈(0.9, 1.1). Preferably, as the air deflector is in a standard position, k₁=1. The standard position is a preset position of the air deflector as the air conditioner running, which is preferably set by a preset step signal to the stepping motor configured to drive the air deflector to move. If it is determined that the air deflector rotates from the preset position, the electric heating power Pₜ is being recalculated by calling upon corresponding air deflector correction coefficient. A group of available air deflector correction coefficients are shown in the table as follows.

| | Angles deviated from the standard position | | | | | | |
|---|---|---|---|---|---|---|---|
| | | −20°~ | −10°~ | −5°~ | 5°~ | 10°~ | |
| | <−20° | −10° | −5° | 5° | 10° | 20° | >20° |
| k₁ | 0.94 | 0.96 | 0.98 | 1 | 1.02 | 1.05 | 1.08 |

A detailed description on how to calculate a total power of the outdoor unit is interpreted as follows.

The total power of the outdoor unit includes an outdoor unit main board power P_{g}. The outdoor unit main board power P_{g} is equal to the rated power of the chip, or it is mainly determined by a sum of the working power of the built-in chip and leakage of other standby components in principle. Generally the outdoor unit main board power P_{g} is in a range from 0-5 W. If the outdoor unit main board is selected according to the first input command and the second input command, the data processing device could determine whether the power variation trend of the outdoor unit main board satisfies the preset condition by comparing the detected power variation with the thresholds of the range; if it is within the range, the data processing device stores the power of the module and then outputs.

The total power of the outdoor unit includes a compressor operating power Pₖ, wherein Pₖ=\sqrt{3}UI, in which U indicates the effective value of power supply voltage and I indicates the effective value of power supply current. Preferably, the method for detecting operating power of compressor of air conditioner as described above is used to determine the compressor operating power, which comprises procedures:

Firstly detecting a compressor driving power supply frequency f as the air conditioner running;

Then calculating a drive power supply period T based on the detected drive power supply frequency f, wherein the drive power supply period T=1/f.

The driving power supply period T is equally divided into n time segments; and in each time segment, respectively sampling a compressor drive voltage and recording as U₁, U₂, U₃, . . . , Uₙ;

Respectively sampling a compressor drive current in each time segment and recording as I₁, I₂, I₃, . . . , Iₙ;

Calculating a voltage reference value U′, wherein

$${U}^{′} = \sqrt{\frac{{U}_{1}^{2} + {U}_{2}^{2} + {U}_{3}^{2} + ⋯ + {U}_{n}^{2}}{n}} ;$$

Calculating a current reference value I′, wherein

$${I}^{′} = \sqrt{\frac{{I}_{1}^{2} + {I}_{2}^{2} + {I}_{3}^{2} + ⋯ + {I}_{n}^{2}}{n}} ;$$

Obtaining a plurality of voltage reference values U′ and denoted as U₁′, U₂′, U₃′, . . . , Uₓ′;

Obtaining a plurality of current reference values I′ and denoted as I₁′, I₂′, I₃′, . . . , Iₓ′;

Calculating a mean voltage reference value Uₘₑₐₙ, wherein

$${U}_{m e a n} = \frac{{U}_{1}^{′} + {U}_{2}^{′} + … + {U}_{x}^{′}}{x} ;$$

Calculating a mean current reference value Iₘₑₐₙ, wherein

$${I}_{m e a n} = \frac{{I}_{1}^{′} + {I}_{2}^{′} + … + {I}_{x}^{′}}{x} ;$$

Calculating a compressor operating power P_{compressor}, P_{compressor}=\sqrt{3}UₘₑₐₙIₘₑₐₙ.

The total power of the outdoor unit includes an outdoor fan power P_{f2}. As determining the outdoor fan power P_{f2}, it is necessary to determine whether a DC fan or an AC fan is used.

If the outdoor fan is a DC fan, the outdoor fan power P_{f2} could be detected by measuring a drive duty ration of the outdoor fan. If the drive duty ratio of the outdoor fan d<d₁, the outdoor fan power P_{f2}=P₁; if the drive duty ratio of the outdoor fan satisfies dₘ₋₁<d<dₘ, the outdoor fan power

$${P}_{f 1} = ( {P}_{m} - {P}_{m - 1} ) \frac{d - {d}_{m - 1}}{{d}_{m} - {d}_{m - 1}} + {P}_{m - 1} ;$$

if the drive duty ratio of the outdoor fan d>d_{q}, the outdoor fan power P_{f2}=Pq, where 1≤m≤q, m,q are integers, m and q∈[1,5], where d₁, dₘ₋₁, dₘ, d_{q} are constants increasing, and P₁, Pₘ₋₁, Pₘ are preset values increasing; preferably, q=5, d₁=10%, d₂=30%, d₃=60%, d₄=85%, d₅=95%, P₁=7 W, P₂=22 W, P₃=46 W, P₄=90 W, P₅=110 W. For example, if the drive duty ratio of the outdoor fan is 70%, the outdoor fan power P_{f1}=

$$( {P}_{m} - {P}_{m - 1} ) \frac{d - {d}_{m - 1}}{{d}_{m} - {d}_{m - 1}} + {P}_{m - 1} = 63.6 W .$$

As being applied to calculate the power of other types of air conditioner, merely adjustments on the constants according to the capabilities of various motors should be made such that the electricity consumption of the outdoor fan could be obtained independently and there is no need to deduce new empirical formulas according to results from redetections.

Because typically an AC fan is applied an open loop control, both for the two-speed AC fan and the single-speed AC fan, if the outdoor fan is an AC fan, firstly selecting a rated power preset value P_{f2′} according to the speed of the outdoor fan. To be specific, setting two fan speed categories and each of the fan speed category is assigned a rated power, which are denoted by P₀₁ and P₀₂; determining which fan speed category the current fan speed belongs to and selecting corresponding rated power as the rated power preset value P_{f2′}. According to different application scenarios, more rated power values could be provided and configured as the rated power preset value P_{f2′}.

The outdoor fan power P_{f2} is equal to the result by multiplying the rated power preset value P_{f2′} and a voltage correction coefficient k₂, and the outdoor fan power P_{f2} increases as the mains voltage increases, k₂∈(0.9, 1.1). A group of available voltage correction coefficients are shown in the table as follows.

| Main voltage (V) | <200 | <210 | 200 | >230 | >240 |
|---|---|---|---|---|---|
| k₂ | 0.9 | 0.95 | 1 | 1.05 | 1.1 |

The total power of the outdoor unit includes an electronic expansion valve power, which is denoted by P_{d}. The electronic expansion valve power P_{d} is equal to the rated power of the electronic expansion valve. The action of the electronic expansion valve is very quick and the power is usually between 0 to 5 W, preferably the electronic expansion valve power P_{d} is set as 3 W.

The total power of the outdoor unit includes a four-way valve power, which is denoted by Pₛ. The four-way valve power is equal to the rated power of the four-way valve. The action of the four-way valve takes place in the heating mode and the power is usually between 0 to 5 W, preferably the four-way valve power Pₛ is set as 4 W.

In this embodiment, modules in the indoor unit or in the outdoor unit are determined independently, in which errors caused by the coupled relationship could be properly corrected, such that the accuracy of data could be ensured and power of each of the single module could be determined, called upon and used independently to calculate electricity consumption of the timing period. According to experiment results, error on the calculation of electricity consumption could be reduced below 5%.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

1: An air conditioner compressor operating power detecting method comprising:
detecting a compressor driving power supply frequency f as the air conditioner running;
calculating a drive power supply period T based on the detected drive power supply frequency f, wherein the drive power supply period T=1/f;
the driving power supply period T is equally divided into n time segments; and in each time segment, respectively sampling a compressor drive voltage, which are denoted as U₁, U₂, U₃, . . . , Uₙ;
respectively sampling a compressor drive current in each time segment, which are denoted as I₁, I₂, I₃, . . . , Iₙ;
calculating a voltage reference value U′, wherein
$${U}^{′} = \sqrt{\frac{{U}_{1}^{2} + {U}_{2}^{2} + {U}_{3}^{2} + … + {U}_{n}^{2}}{n}} ;$$
calculating a current reference value I′, wherein
$${I}^{′} = \sqrt{\frac{{I}_{1}^{2} + {I}_{2}^{2} + {I}_{3}^{2} + … + {I}_{n}^{2}}{n}} ;$$
obtaining a plurality of voltage reference values U′ and which are denoted as U₁′, U₂′, U₃′ . . . Uₓ′;
obtaining a plurality of current reference values I′ and which are denoted as I₂′, I₂′, I₃′ . . . Iₓ′;
calculating a mean voltage reference value Uₘₑₐₙ, wherein
$${U}_{m e a n} = \frac{{U}_{1}^{′} + {U}_{2}^{′} + … + {U}_{x}^{′}}{x} ;$$
calculating a mean current reference value Iₘₑₐₙ, wherein
$${I}_{m e a n} = \frac{{I}_{1}^{′} + {I}_{2}^{′} + … + {I}_{x}^{′}}{x} ;$$
and
calculating a compressor operating power P_{compressor}, P_{compressor}=\sqrt{3}UₘₑₐₙIₘₑₐₙ.

2: The air conditioner compressor operating power detecting method according to claim 1, wherein n∈[30, 50] and n is a positive integer.

3: The air conditioner compressor operating power detecting method according to claim 1, wherein x∈[10, 25], x is a positive integer.

4: An air conditioner using a method to detect the operating power of a compressor within, wherein the method comprises:
detecting a compressor driving power supply frequency f as the air conditioner running;
calculating a drive power supply period T based on the detected drive power supply frequency f, wherein the drive power supply period T=1/f;
the driving power supply period T is equally divided into n time segments; and in each time segment, respectively sampling a compressor drive voltage, which are denoted as U₁, U₂, U₃, . . . , Uₙ;
respectively sampling a compressor drive current in each time segment, which are denoted as I₁, I₂, I₃, . . . , Iₙ;
calculating a voltage reference value U′, wherein
$${U}^{′} = \sqrt{\frac{{U}_{1}^{2} + {U}_{2}^{2} + {U}_{3}^{2} + … + {U}_{n}^{2}}{n}} ;$$
calculating a current reference value I′, wherein
$${I}^{′} = \sqrt{\frac{{I}_{1}^{2} + {I}_{2}^{2} + {I}_{3}^{2} + … + {I}_{n}^{2}}{n}} ;$$
obtaining a plurality of voltage reference values U′ and which are denoted as U₁′, U₂′, U₃′ . . . Uₓ′;
obtaining a plurality of current reference values I′ and which are denoted as I₁′, I₂′, I₃′ . . . Iₓ′;
calculating a mean voltage reference value Uₘₑₐₙ, wherein
$${U}_{m e a n} = \frac{{U}_{1}^{′} + {U}_{2}^{′} + … + {U}_{x}^{′}}{x} ;$$
calculating a mean current reference value Iₘₑₐₙ, wherein
$${I}_{m e a n} = \frac{{I}_{1}^{′} + {I}_{2}^{′} + … + {I}_{x}^{′}}{x} ;$$
and
calculating a compressor operating power P_{compressor}, P_{compressor}=\sqrt{3}UₘₑₐₙIₘₑₐₙ.

5: The air conditioner according to claim 4, wherein when calculating an operating power of an indoor unit:
an indoor unit main board power P_{g′} is equal to the rated power of the chip;
an indoor display module power Pₓ is equal to a sum of a power of a control board of the indoor display module and a total power of signal lights radiating;
an indoor fan power P_{f1}: if the drive duty ratio of the indoor fan d<d₁, the indoor fan power P_{f1}=P₁; if the drive duty ratio of the indoor fan satisfies dₘ₋₁<d<dₘ, the indoor fan power
$${P}_{f 1} = ( {P}_{m} - {P}_{m - 1} ) \frac{d - {d}_{m - 1}}{{d}_{m} - {d}_{m - 1}} + {P}_{m - 1} ;$$
it the drive duty ratio of the indoor fan d>d_{q}, the indoor fan power P_{f1}=P_{q}, where 1≤m≤q, m, q are integers, m and q∈[1,5], where d₁, dₘ₋₁, dₘ, d_{q} are constants increasing, and P₁, Pₘ₋₁, Pₘ are preset values increasing;
an electric heating power Pₜ is equal to a rated electric heating power Pₜ₀; and
a total indoor unit power P_{indoor}, which satisfies P_{indoor}=P_{g′}+Pₓ+P_{f1}+Pₜ.

6: The air conditioner according to claim 4, wherein when calculating an operating power of an indoor unit:
an indoor unit main board power P_{g′} is equal to the rated power of the chip;
an indoor display module power Pₓ is equal to a sum of a power of a control board of the indoor display module and a total power of signal lights radiating;
an indoor fan power P_{f1}: if the drive duty ratio of the indoor fan d<d₁, the indoor fan power P_{f1}=P₁; if the drive duty ratio of the indoor fan satisfies dₘ₋₁<d<dₘ, the indoor fan power
$${P}_{f 1} = ( {P}_{m} - {P}_{m - 1} ) \frac{d - {d}_{m - 1}}{{d}_{m} - {d}_{m - 1}} + {P}_{m - 1} ;$$
if the drive duty ratio of the indoor fan d>d_{q}, the indoor fan power P_{f1}=P_{q}, where 1≤m≤q, m, q are integers, where d₁, dₘ₋₁, dₘ, d_{q} are constants increasing, and P₁, Pₘ₋₁, Pₘ are preset values increasing;
an electric heating power Pₜ is equal to a sum of a preset electric heating power Pₜ₀ and a compensated electric heating power P_{t′}, corresponding to each of the data segments of the drive duty ration of the indoor fan a corresponding correction weight w is assigned; within each of the range, the compensated electric heating power P_{t′} increases as the drive duty ratio of the indoor fan increases and the increment of the compensated electric heating power P_{t′} is equal to an accumulated value of each of multiplication result of the segment and the correction weight w;
as the indoor fan is running, the electric heating power Pₜ satisfies Pₜ=(Pₜ₀+P_{t′})×k₁, wherein k₁ is an air deflector correction coefficient and the air deflector correction coefficient increases as the angle of the air deflector from the original position increases, and k₁∈(0.9, 1.1); and
a total indoor unit power P_{indoor}, which satisfies P_{indoor}=P_{g′}+Pₓ+P_{f1}+Pₜ.

7: The air conditioner according to claim 6, wherein when calculating an operating power of an outdoor unit:
an outdoor unit main board power P_{g} is equal to the rated power of the chip;
an outdoor fan power P_{f2} is:
if the outdoor fan is a DC fan, the outdoor fan power P_{f2} could be detected by measuring a drive duty ration of the outdoor fan. If the drive duty ratio of the outdoor fan d<d₁, the outdoor fan power P_{f2}=P₁; if the drive duty ratio of the outdoor fan satisfies dₘ₋₁<d<dₘ, the outdoor fan power
$${P}_{f 1} = ( {P}_{m} - {P}_{m - 1} ) \frac{d - {d}_{m - 1}}{{d}_{m} - {d}_{m - 1}} + {P}_{m - 1} ;$$
if the drive duty ratio of the outdoor fan d>d_{q}, the outdoor fan power P_{f2}=Pq, where 1≤m≤q, m,q are integers, where d₁, dₘ₋₁, dₘ, d_{q} are constants increasing, and P₁, Pₘ₋₁, Pₘ are preset values increasing;
if the outdoor fan is an AC fan, firstly selecting a rated power preset value P_{f2′} according to the speed of the outdoor fan; the outdoor fan power P_{f2} is equal to the result by multiplying the rated power preset value P_{f2′} and a voltage correction coefficient k₂, and the outdoor fan power P_{f2} increases as the mains voltage increases, k₂∈(0.9, 1.1);
an electronic expansion valve power P_{d} is equal to the rated power of the electronic expansion valve;
a four-way valve power is equal to the rated power of the four-way valve; and
a total indoor unit power P_{outdoor}, which satisfies P_{outdoor}=P_{g}+P_{f2}+P_{d}+Pₛ+P_{compressor}.

8: The air conditioner according to claim 9, wherein if the outdoor fan is an AC fan, t setting two fan speed categories and each of the fan speed category is assigned a rated power, which are denoted by P₀₁ and P₀₂; determining which fan speed category the current fan speed belongs to and selecting corresponding rated power as the rated power preset value P_{f2′}.

9: The air conditioner according to claim 4, wherein n∈[30, 50] and n is a positive integer.

10: The air conditioner according to claim 4, wherein x∈[10, 25], x is a positive integer.
